(19) United States
(12) Patent Application Publication
(10) Pub. No.: US 2024/0267281 A1
(43) Pub. Date: Aug. 8, 2024

(54) SYSTEM AND METHOD FOR CONTROLLING CPE ACTION FREQUENCY USING CONTENTION TIMER

(71) Applicant: Rakuten Mobile, Inc., Tokyo (JP)

(72) Inventors: Mohit LUTHRA, Singapore (SG); Vijay KUMAR, Indore (IN)

(21) Appl. No.: 17/997,737

(22) PCT Filed: Aug. 23, 2022
(86) PCT No.: PCT/US2022/041154

§ 371 Date: Nov. 2, 2022

(51) Int. Cl. H04L 41/0654; H04L 41/0233; H04L 41/22

(52) U.S. Cl. CPC H04L 41/0654; H04L 41/22; H04L 41/0233

(57) ABSTRACT

A system includes processing circuitry; and a memory connected to the processing circuitry, wherein the memory is configured to store executable instructions that, when executed by the processing circuitry, facilitate performance of operations, including receive contention timer parameters corresponding to a business-policy; receive one or more event messages from network element groups; filter the one or more event messages for monitoring; generate an action to be initiated by an action resource in response to a detected fault; and initiate a contention timer in response to the generation of the action to be taken by the action resource based on the detected fault.

### TECHNICAL FIELD

This description relates to a system for controlling CPE action frequency using a contention timer and method of using the same.

### BACKGROUND

Event-driven architecture (EDA) is a software architecture promoting the production, detection, consumption of, and reaction to events. An event is a change in state, or an annotated label based on an entity's log output in a system. For example, when a consumer purchases an online product, the product's state changes from “for sale” to “sold”. A seller's system architecture treats this state change as an event whose occurrence is made known to other applications within the architecture.

What is produced, published, propagated, detected, or consumed is a message called the event notification, and not the event, which is the state change that triggered the message emission. Events occur and event messages are generated and propagated to report the event that occurred. Nevertheless, the term event is often used metonymically to denote the notification event message. The EDA is often designed atop message-driven architectures, where such a communication pattern includes one of the inputs to be text-based (e.g., the message) to differentiate how each communication is handled.

### SUMMARY

In some embodiments, a system includes processing circuitry; and a memory connected to the processing circuitry, wherein the memory is configured to store executable instructions that, when executed by the processing circuitry, facilitate performance of operations, including receive contention timer parameters corresponding to a business-policy; receive one or more event messages from network element groups; filter the one or more event messages for monitoring; generate an action to be initiated by an action resource in response to a detected fault; and initiate a contention timer in response to the generation of the action to be taken by the action resource based on the detected fault.

In some embodiments, a method executed by a processor includes receiving contention timer parameters corresponding to a business-policy; receiving one or more event messages from network element groups; filtering the one or more event messages for monitoring; generating an action to be initiated by an action resource in response to a detected fault; and initiating a contention timer in response to the generation of the action to be taken by the action resource based on the detected fault.

In some embodiments, a non-transitory, tangible computer readable storage medium storing a computer program, wherein the computer program contains instructions that when executed, cause a processor to perform operations including receive contention timer parameters corresponding to a business-policy; receive one or more event messages from network element groups; filter the one or more event messages for monitoring; generate an action to be initiated by an action resource in response to a detected fault; and initiate a contention timer in response to the generation of the action to be taken by the action resource based on the detected fault.

### BRIEF DESCRIPTION OF THE DRAWINGS

Aspects of the present disclosure are best understood from the following detailed description read with the accompanying FIGS. In accordance with the standard practice in the industry, various features are not drawn to scale. The dimensions of the various features are arbitrarily increased or reduced for clarity of discussion.

FIG. 1 is a block diagram of a correlation and policy engine (CPE), in accordance with some embodiments.

FIG. 2 is a diagrammatic representation a correlation and policy engine (CPE), in accordance with some embodiments.

FIG. 3 is a pictorial diagram representation a correlation and policy engine (CPE), in accordance with some embodiments.

FIG. 4 is a flow diagram of a method for policy correlation and action management, in accordance with some embodiments.

FIG. 5 is a data flow diagram of a method for controlling CPE action, in accordance with some embodiments.

FIG. 6A is a graphical user interfaces (GUIs) for a correlation and policy engine (CPE), in accordance with some embodiments.

FIG. 6B is a box graph of a policy for identification of network functions or network services, in accordance with some embodiments.

FIG. 7 is a high-level functional block diagram of a correlation and policy processor-based system, in accordance with some embodiments.

### DETAILED DESCRIPTION

The following disclosure includes many different embodiments, or examples, for implementing different features of the subject matter. Examples of components, values, operations, materials, arrangements, or the like, are described below to simplify the present disclosure. These are, of course, examples and unintended to limit. Other components, values, operations, materials, arrangements, or the like, are contemplated. For example, the formation of a first feature over or on a second feature in the description that follows include embodiments in which the first and second features are formed in direct contact, and further include embodiments in which additional features are formed between the first and second features, such that the first and second features are unable to contact directly. In addition, the present disclosure repeats reference numerals and/or letters in the various examples. This repetition is for the purpose of simplicity and clarity and any indication of a relationship between the various embodiments and/or configurations discussed is unintended.

Further, spatially relative terms, such as “beneath,” “below,” “lower,” “above,” “upper” and the like, are usable herein for ease of description to describe one element or feature's relationship to another element or feature as illustrated in the FIGS. The spatially relative terms are intended to encompass different orientations of the device in use or operation in addition to the orientation depicted in the FIGS. The apparatus is otherwise oriented (rotated 90 degrees or at other orientations) and the spatially relative descriptors usable herein likewise are interpreted accordingly.

An EDA architectural pattern is applied by the design and implementation of applications and systems that transmit event messages among loosely coupled software components and services. An event-driven system typically consists of event emitters (agents, data sources), event consumers (sinks), and event channels (the medium the event messages travel from emitter to consumer). Event emitters detect, gather, and transfer event messages. An event emitter is unable to know the consumers of the event messages, the event emitter is unable to even know whether an event consumer exists, and in the event the consumer exists, the event emitter is unable to know how the event message is used or further processed. Event consumers apply a reaction as soon as an event message is presented. The reaction is or is not completely provided by the event consumer. For example, the event consumer filters the event message frame while the event policy executes and produces transformation and forwards the event message frame to another component or the event consumer supplies a self-contained reaction to such event message frame. Event channels are conduits in which event message frames are transmitted from event emitters to event consumers. In some embodiments, event consumers become event emitters after receiving event message frame and then forwarding the event message frame to other event consumers. The configuration of the correct distribution of event message frames is present within the event channel. The physical implementation of event channels is based on components, such as message-oriented middleware or point-to-point communication, which might rely on a more appropriate transactional executive framework (such as a configuration file that establishes the event channel).

A correlation and policy engine (CPE) is a software application that programmatically understands relationships. CPEs are configured to be used in system management tools to aggregate, normalize, and analyze event data. Event correlation is a technique for making sense of many events and pinpointing the few events that are important in a mass of information. This is accomplished by looking for and analyzing relationships between events. Further, a CPE is a program or process that receives machine-readable policies and applies them to a particular problem domain to constrain the behavior of network resources.

In programming and software design, an event is a change of state (e.g., an action or occurrence) recognized by software, often originating asynchronously from the external environment that is handled by the software. Computer event messages are generated or triggered by a system, by a user, or in other ways based upon the event. Event messages are handled synchronously with the program flow; that is, the software is configured to have one or more dedicated places (e.g., a data sink) where event messages are handled. A source of event messages includes the user, who interacts with the software through the computer's peripherals; for example, by typing on a keyboard. Another source is a hardware device such as a timer. Software is configured to further trigger the software's own set of event messages into the event channel (e.g., to communicate the completion of a task). Software that changes behavior in response to event messages is said to be event-driven, often with the goal of being interactive.

A policy manager is rule based policy engine which triggers actions towards northbound systems based upon matching the condition defined for events received from southbound systems.

A policy manager determines the degree to which a service/device is allowed to do what the service/device is attempting/requesting (decision) and is then able to enforce the decision (enforcement). Some examples of policies include (1) is the customer allowed to use this service, (2) is there enough capacity to support this new service, (3) what happens to non-SLA (service level agreement) customers when a node approaches congestion, and (4) is the service request/activity a security threat?

A rule-based system is used to store and manipulate knowledge to interpret information in a useful way. Normally, the term rule-based system is applied to systems involving human-crafted or curated rule sets.

A northbound interface is an application programming interface (API) or protocol that allows a lower-level network component to communicate with a higher-level or more central component, while a southbound interface allows a higher-level component to send commands to lower-level network components.

Typically, an event occurrence will trigger far too many actions to be taken by the targeted northbound system within a small-time window. For example, for a CPU load usage policy, if an email notification is sent to a northbound system when the CPU load is more than 80%, and a CPU load counter occurs every 15 seconds, a large amount of event email notifications is received by the northbound system. In a non-limiting example, in one minute four emails are sent, in five minutes twenty emails are sent, and in ten minutes forty emails are sent. In some embodiments, the frequency of the action taken (e.g., the email sent) is limited to avoid a large amount of action events.

In some embodiments, to avoid multiple actions for the same event, a contention timer feature is implemented. The contention timer feature controls the frequency of actions performed for events to the target. Thus, by using a contention period, an action won't be repeated for certain duration.

In some embodiments, performance management is improved by limiting the number of actions sent to northbound systems. The contention timer feature avoids repeated action requests from a policy manager (e.g., the CPE directed towards northbound systems such as the ticket creation system or action manager, email notification system, and orchestrator (LCM) systems).

In some embodiments, the contention timer feature allows both configurable and auto provisioning of a period before executing subsequent actions on network elements which have already recently executed some action.

In some embodiments, the contention timer is configurable (e.g., user-defined) or auto provisioned. For example, if a policy action for a network element is triggered, the contention timer counter is activated for this network element which would dis-allow any subsequent action when the contention timer is active.

Regardless of a successful action or a failed action, a contention timer period is established independently. For example, in the event of a failed action, the contention timer is activated after three failure attempts. In another non-limiting example, when a policy manager triggers a workflow action, such as re-starting a network function, three retries before a failure scenario is considered before activating the contention timer period. But, in the event of a successfully triggered action, the contention timer is activated after the first trigger.

In some embodiments, the contention timer feature is a feature applied to many use cases, such as an auto populated contention timer feature or a user defined contention timer.

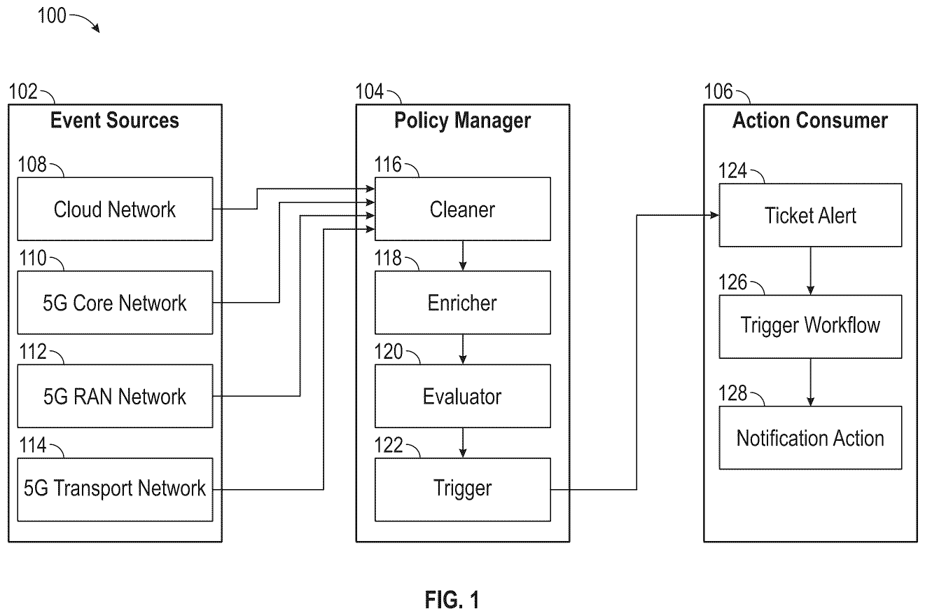

FIG. 1 is a block diagram of a correlation and policy engine (CPE) 100, in accordance with some embodiments.

CPE 100 generally includes an event sources input block 102, policy manager block 104, and an action consumer block 106.

Event sources input block 102 includes event emitters (agents, data sources, and other suitable event emitters within embodiments of the present invention). Event emitters detect, gather, and transfer event messages. An event emitter is unable to know the consumers of the event messages, the event emitter is unable to even know whether an event consumer exists, and in the event the consumer exists, the event emitter is unable to know how the event message is used or further processed.

Event sources 102 include events from a cloud network 108. Cloud network computing is on-demand availability of computer system resources, especially data storage (e.g., cloud storage) and computing power, without direct active management by the user. Large clouds often have functions distributed over multiple locations, each location being a data center. Event sources from cloud network 108 are events occurring in the cloud network. In a non-limiting example, one or more incidents occurring within a data center (a building, a dedicated space within a building, or a group of buildings used to house computer systems and associated components, such as telecommunications and storage systems) of cloud network 108.

Event sources 102 include events from a 5G core network (CN) 110. A backbone or CN 110 is a part of a computer network which interconnects networks, providing a path for the exchange of information between different local area networks (LANs) or subnetworks. A CN ties together diverse networks in the same building, in different buildings in a campus environment, or over wide areas. A large corporation that has many locations has a CN that ties the locations together, for example, in response to a server cluster needing to be accessed by different departments of a company that are located at different geographical locations. The pieces of the network connections (for example: ethernet, wireless) that bring these departments together is often referred to as the CN. One example of a CN is the Internet backbone. Event sources from 5G CN 110 are events occurring in the 5G CN. In a non-limiting example, one or more incidents occurring within a server cluster (a set of servers that work together and viewed as a single system where each node is set to perform the same task, controlled, and scheduled by software) of 5G CN 110.

Event sources 102 include events from a 5G radio access network (RAN) network 112. A RAN is part of a mobile telecommunication system. RAN implements a radio access technology. RANs reside between a device such as a mobile phone, a computer, or remotely controlled machines and provides connection with a CN, such as CN 110. Depending on the standard, mobile phones and other wireless connected devices are varyingly known as user equipment (UE), terminal equipment, mobile station (MS), or other suitable equipment within embodiments of the present disclosure. Examples of radio access network types include global system for mobile communications (GSM) radio access network, GSM RAN (GRAN), GERAN (essentially the same as GRAN but specifying the inclusion of EDGE packet radio services), universal mobile telecommunications system (UMTS) RAN, UMTS terrestrial RAN (UTRAN), and E-UTRAN (e.g., long term evolution (LTE) high speed and low latency radio access network). Event sources from 5G RAN 112 are events occurring in the 5G RAN. In a non-limiting example, one or more incidents occurring within terminal equipment and or mobile stations of 5G RAN 112.

Event sources 102 include events from 5G transport networks 114. 5G transport networks 114 include fronthaul and backhaul portions.

The backhaul portion of a network includes the intermediate links between the CN, such as CN 110 and small subnetworks at the edge of a network. The most common network type in which backhaul is implemented is a mobile network. A backhaul of a mobile network, also referred to as mobile-backhaul that connects a cell site to the CN. Two methods of mobile backhaul implementations are fiber-based backhaul and wireless point-to-point backhaul. In both the technical and commercial definitions, backhaul generally refers to the side of the network that communicates with the global Internet. Sometimes middle mile networks exist between the customer's own LAN and those exchanges. In some embodiments, this is a local wide area network (WAN) connection.

A fronthaul network is coincident with the backhaul network, but subtly different. In a cloud RAN (C-RAN) the backhaul data is decoded from the fronthaul network at centralized controllers, from where the backhaul data is then transferred to the CN. The fronthaul portion of a C-RAN includes the intermediate links between the centralized radio controllers and the radio heads (or masts) at the edge of a cellular network. Event sources from 5G transport networks 114 are events occurring in the 5G transport networks 114. In a non-limiting example, one or more incidents occurring within radio controllers or network switches of 5G transport networks 114.

Policy Manager 104 is a real-time complex event processing (CEP consists of a set of concepts and techniques for processing real-time events and extracting information from event streams as they arrive) engine at scale, which automates various workflows and network healing operations. CPE 100 processes events based on policies. Based upon pre-defined policies and rules policy manager 104 filters the events, enriches the events, correlates, and processes the events for action.

Policy manager 104 includes cleaner 116 that accepts the events from event sources block 102, removes unwanted events, and passes the filtered events to enricher 118 for further processing. In some embodiments, these filtered events are forwarded by using a message-policy cache built by a message-policy sync process. In computing messages are passed between programs or between components of a single program. Message passing is a form of communication used in concurrent and parallel computing, object-oriented programming, and channel communication, where communication is made by sending messages to recipients. A message is sent to an object specifying a request for action.

Policy manager 104 includes enricher 118 which enriches the messages arriving from cleaner 116 with inventory information to successfully execute a policy. In some embodiments, enricher 118 is configured with a message-enrichment cache built by an enricher sync process. In a non-limiting example, received event data is missing fields or parameters. Events are then enriched with the help of an inventory to fill the missing fields and parameters, so decisions are made, and predetermined actions occur.

Policy manager 104 includes evaluator 120 that evaluates and processes the enriched events arriving from enricher 118. Evaluator 120 is configured to identify root causes (e.g., what is causing or initiating the received events), decide relevant actions pursuant to predetermined policies, and inform action manager 120 accordingly.

Policy manager 104 includes trigger 122 that matches a policy with an event based the output of evaluator 120 identifying the root causes of the received events. Trigger 122 then forwards the matched policy/event to action consumer 106 to begin an action workflow.

Action consumer 106 includes ticket alert 124. Ticket alert 124 creates an incident creation or a trigger to begin a workflow action.

Action consumer 106 includes trigger workflow 126. In some embodiments, trigger workflow 126 performs actions based on a user-created policy. In some embodiments, trigger workflow 126 initiates the sending of a notification. In some embodiments, trigger workflow 126 initiates a reboot, restart, scale in, scale out, or other suitable actions within embodiments of the present disclosure.

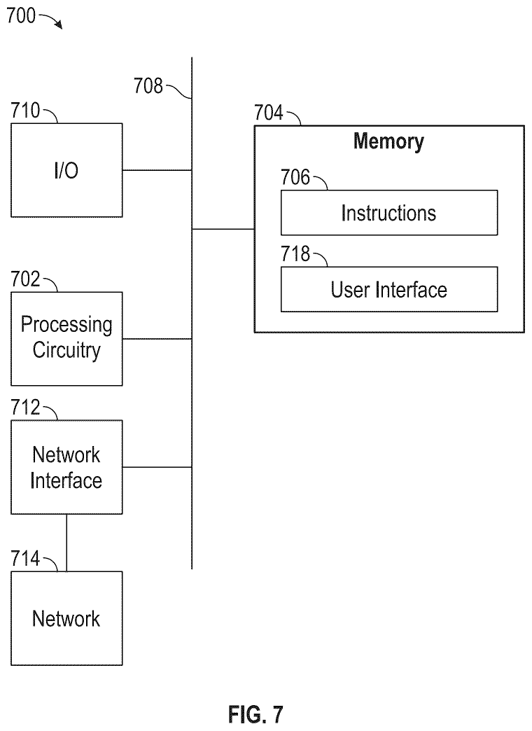

Action consumer 106 includes a notification action 128. In some embodiments, notification action 128 is an email, text message or graphical user interface (GUI) display on a user interface, such as user interface 818 (FIG. 7) notifying the policy creator and/or network operator an event was received, diagnosed, an action taken, and the result of the action taken (e.g., the action taken was successful or failed).

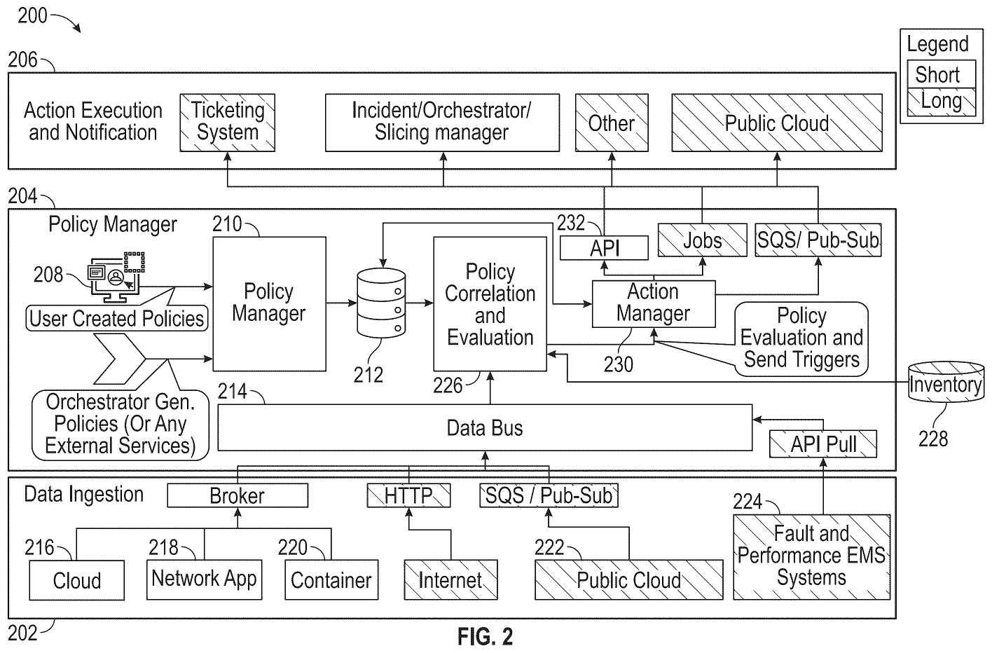

FIG. 2 is a diagrammatic representation a correlation and policy engine (CPE) 200, in accordance with some embodiments.

In some embodiments, CPE 200 is like CPE 100. In some embodiments, event sources 202 is like data ingestion block 102, policy manager 204 is like policy manager 104, and action consumer 206 is like action manager 106.

Policy Manager 204 is a real-time CEP engine at scale, which automates various workflows and network healing operations (e.g., repair and/or restoration). Policy manager 204 processes events based on predetermined policies and/or rules. Policy manager 204 filters the events, enriches the events, correlates, and processes the events for action. Policy manager 204 provides a framework to support CEP capabilities. In some embodiments, in memory computation logic mitigates latency issues. In some embodiments, multi-source events ingestion covers broader use cases in complex networks and infrastructure. In some embodiments, policy manager 204 is configured with scalable architecture based upon a business requirement (e.g., a new business policy being implemented). In some embodiments, policy manager 204 supports multiple computation logic in near-real time processing, such as event followed by, event AND, event OR, count of event occurrences, and mathematical operations on event counters. In a non-limiting example, the computation logic supports performing an action managed by action manager 230 in response to XYZ event, followed by ABC event, AND (UVW event OR DEF event) along with ten event GHI occurrences. In some embodiments, policy queries are applied on a potentially infinite stream of data. In some embodiments, events are processed immediately. In some embodiments, once policy manager 204 processes all events for a matching sequence, results are driven directly. In some embodiments, this aspect effectively leads to policy manager 204 having a near real-time capability.

Users and/or network operators create policy templates using UI 208. In some embodiments, UI 208 is configured with GUIs that are configured to allow a user to view policy creation templates where the user enters information to create a policy. In some embodiments, UI 208 is like UI 818. In some embodiments, an orchestrator (orchestration is the automated configuration, coordination, and management of computer systems and software) provides general policies, artificial intelligence (AI) generated policies or policies from any external service. The generated policies are sent to policy manager 210 and policy manager 210 relays the created policies to database 212.

The created policy templates are saved in database 212 as a draft. The policy templates are configured to be validated, activated, de-activated, edited, and deleted. Thus, templates are stored in database 212 until needed and then activated upon command by a user.

Data bus 214 receives data from various sources from data ingestion block 202, such as cloud platform 216, network applications 218, container applications 220, other events through the Internet, events through a public cloud 222, and events through a fault and performance system 224.

In response to received event data at data bus 214 missing fields and/or parameters, these events with missing fields and/or parameters are enriched at policy correlation and evaluation (PCE) module 226 through inventory 228 that provides the missing fields and/or parameters, to make decisions and take predetermined actions. In some embodiments, this is referred to as inventory enrichment.

PCE module 226 logically evaluates and processes the events from data bus 214 based on policies from policy manager 210. PCE 226 is configured to identify root causes of events, determine relevant actions pursuant to the predetermined policies, and inform action manager 230 accordingly of any relevant actions pursuant to the predetermined policies.

Action manager 230 accepts the results after event processing by PCE 226 and takes the corresponding action related to that result. In a non-limiting example, action manager 320 sends an email, sends a request to an API endpoint 232, or other suitable action within embodiments of the present disclosure. Action Manager 230 obtains the status of the executed action and updates the database 212 so that users visualize a job status in UI 208.

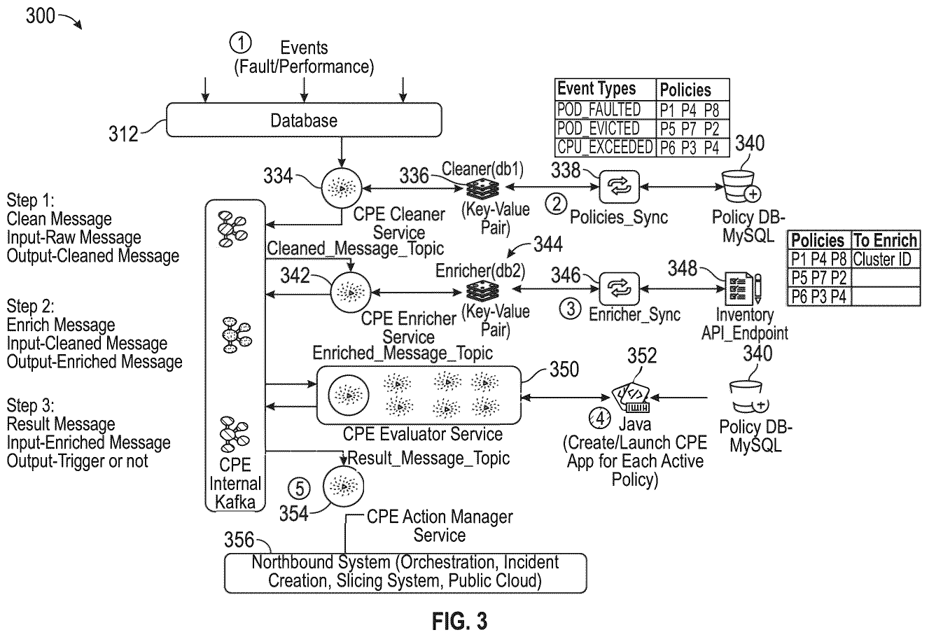

FIG. 3 is a pictorial diagram representation a correlation and policy engine (CPE) 300, in accordance with some embodiments.

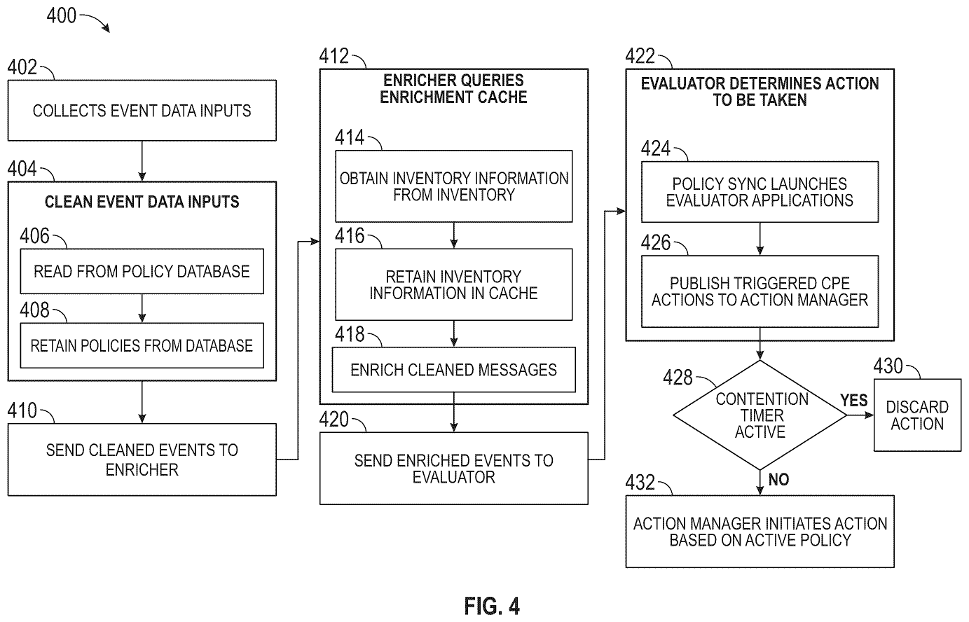

FIG. 4 is a pictorial diagram representation of a method for implementing a correlation and policy engine (CPE) 400, in accordance with some embodiments.

FIGS. 3 and 4 are discussed together to provide an understanding of the operation of CPE 300 through method for implementing a correlation and policy engine (CPE) 400. In some embodiments, method for implementing a CPE 400 is a functional overview of a CPE, such as CPEs 300, 200, or 100. Method 400 is executed by processing circuitry 702 discussed below with respect to FIG. 7. In some embodiments, some, or all the operations of method 400 are executed in accordance with instructions corresponding to instructions 706 discussed below with respect to FIG. 7.

Method 400 includes operations 402-432, but the operations are not necessarily performed in the order shown. Operations are added, replaced, order changed, and/or eliminated as appropriate, in accordance with the spirit and scope of disclosed embodiments. In some embodiments, one or more of the operations of method 400 are repeated. In some embodiments, unless specifically stated otherwise, the operations of method 400 are performed in order.

In some embodiments, CPE 300 analyzes, computes, enriches, and evaluates the collected events. In some embodiments, a user creates policy templates through a user interface (UI), such as UI 208 or UI 818. The created policy filters the collected events, enriches the events (e.g., adds any related event data), correlates the enriched event and then processes the enriched event for action. In some embodiments, created policy templates are saved in a database as a draft where a user validates, activates, de-activates, edits, deletes, and other suitable modifications to policy templates within embodiments of the present disclosure. In some embodiments, collected event data is missing parameters and these events are enriched with event data within an inventory so that processing is performed, and actions taken.

A user interface (UI), such as UI 208 or UI 818, is the space where interactions between humans and machines occur. The goal of this interaction is to allow effective operation and control of the machine from the human end, while the machine simultaneously feeds back information that aids the operators' decision-making process. Non-limiting examples of UIs include the interactive aspects of computer operating systems, hand tools, heavy machinery operator controls, and process controls. UIs are composed of one or more layers, including a human-machine interface (HMI) that interfaces machines with physical input hardware such as keyboards, mice, or game pads, and output hardware such as computer monitors, speakers, and printers. A device that implements an HMI is called a human interface device (HID). Other terms for human-machine interfaces are man-machine interface (MMI) and, when the machine in question is a computer, human-computer interface. Additional UI layers may interact with one or more human senses, including: tactile UI (touch), visual UI (sight), auditory UI (sound), olfactory UI (smell), equilibria UI (balance), and gustatory UI (taste).

A database is a structured collection of data. Databases are anything from a simple shopping list to a picture gallery or a place to hold vast amounts of information in a corporate network. A relational database is a digital store collecting data and organizing the collected data according to a relational model. In this model, tables consist of rows and columns, and relationships between data elements all following a logical structure. A relational database management system (RDBMS) is the set of software tools used to implement, manage, and query such a database.

A cache is a hardware or software component that stores data so that future requests for that data are served faster. The data stored in a cache might be the result of an earlier computation or a copy of data stored elsewhere. A cache hit occurs when the requested data is found in a cache, while a cache miss occurs when it unable to be found. Cache hits are served by reading data from the cache, which is faster than recomputing a result or reading from a slower data store; thus, the more requests that are served from the cache, the faster the system performs.

An action is triggered based upon a matched policy. In some embodiments, a CPE core, such as processing circuitry 702 of FIG. 7, logically evaluates and processes the collected events. In some embodiments, the CPE core identifies root causes, decides relevant actions pursuant to predetermined policies (discussed above) and instructs an action manager according to the predetermined policies. In some embodiments, the action manager collects the results of event processing and takes a respective action related to the collected result. In a non-limiting example, the action manage sends an email, sends a request to an application programming interface (API) endpoint, and other suitable actions within embodiments of the present disclosure. In some embodiments, the action manager obtains job status feedback to determine the status of the executed job and update a back-end application at the database, so that users determine a status of the job through a UI.

An API is a connection between computers or between computer programs. An API is a type of software interface, offering a service to other pieces of software. An API specification is a document or standard that describes how to build or use such a connection or interface. A computer system that meets this standard is said to implement or expose an API. The term API refers either to the specification or to the implementation. In contrast to a UI, which connects a computer to a person, an application programming interface connects computers or pieces of software to each other. An API is not intended to be used directly by a person (e.g., the end user) other than a computer programmer who is incorporating the API into the software. An API is often made up of different parts which act as tools or services that are available to the programmer. A program or a programmer that uses one of these parts is said to call that portion of the API. The calls that make up the API are also known as subroutines, methods, requests, or endpoints.

Auto healing operation is triggered through CPE 300. In some embodiments, zero-touch network healing is implemented. In a non-limiting example, a user creates a policy through a UI for network healing (e.g., automatic fault resolution). Continuing with the non-limiting example, in response to a fault event being detected and filtered by CPE 300, the filtered fault activates the user created policy. Continuing with the non-limiting example, CPE 300 sends enrichment request to an inventory for topology information of the affected network function. Continuing with the non-limiting example, CPE 300 sends requests to an orchestrator (orchestration is the automated configuration, coordination, and management of computer systems and software) for a network function restart and CPE 300 updates the job status in a CPE UI, such as UI 208 or UI 818. Continuing with the non-limiting example, based upon the status of the network function restart, a request is made of CPE 300 to take follow up action. For example, in response to the network function restart failing, then CPE 300 sends a request to the orchestrator for a network re-instantiate (e.g., to create again as an instance of a class). Continuing with the non-limiting example, the network re-instantiate request is sent to a cloud adapter that relays the status of the network re-instantiate and the CPE updates the job status in the CPE UI.

Thus, the automatic network healing proceeds from fault detection to fault repair, to repair verification, to status update all based upon a user predetermined policy.

Zero-touch provisioning (ZTP) is a method of setting up devices that automatically configures the device using a switch feature. ZTP helps IT teams quickly deploy network devices in a large-scale environment, eliminating most of the manual labor involved with adding them to a network. ZTP is found in devices and tools such as network switches, routers, wireless access points and firewalls. The goal is to enable IT personnel and network operators to install networking devices without manual intervention. Manual configuration takes time and is prone to human error especially with large amounts of devices being configured. ZTP is faster, reduces the chance of error and ensures configuration consistency. Zero-touch provisioning is also used to automate the system updating process. Using scripts, ZTP connects configuration management platforms and other tools for configuration or updates.

Network topology is the arrangement of elements (e.g., links, nodes, and other suitable elements within embodiments of the present disclosure) of a communication network. Network topology is used to define or describe the arrangement of various types of telecommunication networks, including command and control radio networks, industrial fieldbuses, and computer networks. Network topology is the topological structure of a network and is depicted physically or logically. Topology is an application of graph theory wherein communicating devices are modeled as nodes and the connections between the devices are modeled as links or lines between the nodes. Physical topology is the placement of the various components of a network (e.g., device location and cable installation), while logical topology illustrates how data flows within a network.

In operation 402 of method 400, CPE 300 collects near real time performance and event data inputs. In some embodiments, event data inputs are cloud platform events, network application counters, container counters, internet events, public cloud events, fault and performance events or other suitable events within embodiments of the present disclosure. Database 312 accepts events from one or more sources and publishes the events using CPE input messages so that CPE cleaner 334 subscribes to the events and filters the corresponding events. Process flows from operation 402 to operation 404.

In operation 404 of method 400, CPE cleaner 334 filters unwanted events and passes the filtered events for further processing by message-policy cache 336 built by message-policy sync 338. In some embodiments, message-policy cache 336 is a remote dictionary server such as an in-memory data structure store, used as a distributed, in-memory key-value database, cache, and message broker, with optional durability. Message-policy cache 336 supports various types of abstract data structures, such as strings, lists, maps, sets, sorted sets, hyper-logs, bitmaps, streams, and spatial indices. Process flows from operation 404 to operation 406.

In operation 406 of method 400, message-policy sync 338 reads from policy database 340 the active policies in CPE 300 and creates an active policy cache in massage-policy cache 336 such that the policies with the same triggering event type are grouped together. Process flows from operation 406 to operation 408.

In operation 408 of method 400, message-policy cache 336 retains a cache of the policy information provided by message-policy sync 338. Thus, message-policy cache 336 retains real-time current policy information. Process flows from operation 408 to operation 410.

In operation 410 of method 400, CPE cleaner 334 publishes CPE cleaned messages (cleaned or filtered events) to CPE enricher 342. Process flows from operation 410 to operation 412.

In operation 412 of method 400, CPE enricher 342 enriches the cleaned message from CPE cleaner 334 with inventory information (e.g., filling in any missing parameters) to successfully execute a policy, by using message-enrichment cache 344 built by enricher sync 346. Process flows from operation 412 to operation 414.

In operation 414 of method 400, an enricher sync occurs where enricher sync 346 obtains inventory information from a policy-message enrichment database table (a database table in inventory 348 which has information about what inventory information is to be enriched for each message type) and save the information to message-enrichment cache 344. Thus, CPE enricher 342 quickly identifies whether an event needs enriching (i.e., adding missing data to the event). Process flows from operation 414 to operation 416.

In operation 416 of method 400, message-enrichment cache 344 retains a cache of the information provided by enricher sync 346. Process flows from operation 416 to operation 418.

In operation 418 of method 400, message-enrichment cache 344 enriches information (e.g., using the information from inventory 348) for each cleaned message from CPE cleaner 334. Process flows from operation 418 to operation 420.

In operation 420 of method 400, the enriched CPE enriched messages are sent to CPE evaluator 350. Process flows from operation 420 to operation 422.

In operation 422 of method 400, CPE evaluator 350 performs CEP and determines whether an action is to be triggered based upon the enriched message or not. Process flows from operation 422 to operation 424.

In operation 424 of method 400, there is a CPE evaluator 350 created for each active policy template by policy CPE sync 352. Policy CPE sync 352 is the entity which creates and/or launches the one or more CPE Evaluator applications 350 for each active policy. Process flows from operation 424 to operation 426.

In operation 426 of method 400, triggered CPE actions are published by CPE Evaluators 350. CPE action manager 354 is subscribed to the published CPE actions. Process flows from operation 426 to operation 428.

In operation 428 of method 400, a determination is made as to whether a contention timer is active. To avoid multiple actions for the same target for the same event, the contention timer controls the frequency of actions performed for targeted events. In some embodiments, a user sets a contention timer period (e.g., 60 minutes) where an action initiated during operation 426 of method 400 won't be acted upon or performed. The contention timer feature prevents an overload of actions from the policy manager, such as policy manager 210, towards northbound systems, such as the ticket creation system, email notification system, and orchestrator (LCM) systems within action manager 206 or northbound system 356. In response to the contention timer being active, any triggered action initiated at operation 426 is discarded at operation 430 of method 400. In response to the contention timer not being active, operation proceeds from operation 428 to operation 432.

In operation 432 of method 400, CPE action manger 354 initiates the API trigger to trigger an action which is based upon the CPE evaluator application 350 (e.g., based on the active policy template).

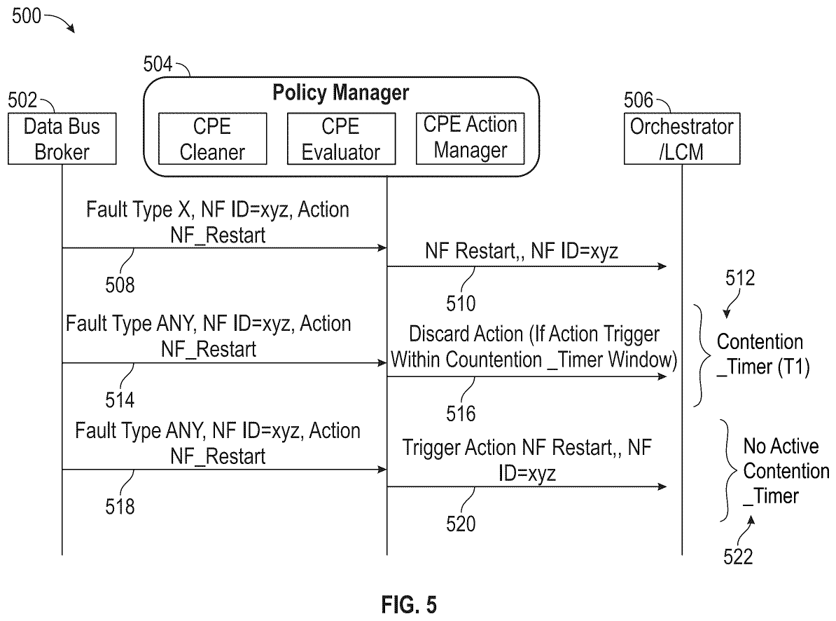

FIG. 5 is a data flow diagram of a method for controlling CPE action 500, in accordance with some embodiments.

In some embodiments, method 500 is executed by processing circuitry 702 discussed below with respect to FIG. 7. In some embodiments, some, or all the operations of method 500 are executed in accordance with instructions corresponding to instructions 706 discussed below with respect to FIG. 7.

Method 500 includes operations 508-522, but the operations are not necessarily performed in the order shown. Operations are added, replaced, order changed, and/or eliminated as appropriate, in accordance with the spirit and scope of disclosed embodiments. In some embodiments, one or more of the operations of method 500 are repeated. In some embodiments, unless specifically stated otherwise, the operations of method 500 are performed in order.

At operation 508 of method 500, data bus broker 502, which is similar to data bus 214 or database 312, sends an event (e.g., a fault message from a network function initiating a network function restart) to policy manager 504, which is similar to policy manager 210, which performs the operations outlined above regarding method 400. Process flows from operation 508 to operation 510.

At operation 510 of method 500, orchestrator 506 initiates a network function restart in response to an action request from policy manager 504. Process flows from operation 510 to operation 512.

At operation 512 of method 500, a contention timer is activated. In a non-limiting example, the contention timer will run for a user-defined period, such as five minutes. In some embodiments, the contention timer is specific to the network function ID (e.g., NF ID=xyz). Process flows from operation 512 to operation 514.

At operation 514 of method 500, another fault event is sent from data bus broker 502 to policy manager 504. In the non-limiting example of FIG. 5, the fault is from the same network function as the fault of operation 508 but the fault at operation 514 is a different fault from the fault at operation 508. In some embodiments, as the contention timer is specific to the network function, that is, the type of fault initiated within the contention timer is irrelevant. Therefore, the contention timer is only concerned with the network function (or network service or server) and is not specific to the fault generate. Alternatively stated, any fault generated after the initiation of a contention timer for a network function (NF), a network service (NS), or a network server is discarded until the contention timer becomes inactive. Process flows from operation 514 to operation 516.

At operation 516 of method 500, any action suggested by policy manager 504 is discarded by orchestrator 506 as the contention timer initiated at operation 512 is still active. Process flows from operation 516 to operation 518.

At operation 518 of method 500, another fault event is sent from data bus broker 502 to policy manager 504. In the non-limiting example of FIG. 5, the fault originates from the same network function as in operation 508. Process flows from operation 518 to operation 520.

At operation 520 of method 500, policy manager 504 triggers an action and sends the action to orchestrator 506. Process flows from operation 520 to operation 522.

At operation 522 of method 500, orchestrator 506 performs the triggered action and starts the contention timer as no contention timer was active.

With reference to Table 1, below, a sample policy action which includes a configurable contention timer period feature in accordance with embodiments of the disclosure is discussed.

As discussed above, the contention timer is based on the prime ID or the ID of the network function, network service, or network server which initiates the contention timer. Therefore, as long as the contention timer is active, an orchestrator, such as orchestrator 506 is configured to avoid taking action on any network function, network service, or server identified by the contention timer (e.g., line 20 of Table 1) and instead discard any suggested action by the policy manager, such as policy manager 504. At line 23 of Table 1, a default for the contention timer is set to 3600 seconds or 60 minutes or 1 hour.

In some embodiments, a contention timer feature is both configurable and auto provisioned for a period that negates executing subsequent actions on network element or target which already has activated a contention timer.

In some embodiments, the contention timer is configurable (e.g., user defined) or auto provisioned (the ability to deploy an information technology or telecommunications service by using pre-defined procedures or policies that are carried out electronically without requiring human intervention). In a non-limiting example, if a policy action for a network element is triggered, the contention timer counter is automatically activated for this network element which disallows any subsequent action if the contention timer is active.

In some embodiments, in the event of a successful action and/or a failed action, the contention timer period is defined independently. In a non-limiting example, in case of a failed action, the contention timer is activated after three failure attempts (e.g., when a policy manager triggers some workflow action to re-start a network function), such as a first action attempt is failed, so re-try is needed. A three retry for failure scenario is considered before activating the contention timer period. However, for successfully triggered actions, the contention timer is activated after first trigger.

With reference to lines 2-15 of table 1, lines 2-15 describe the type of action. Lines 2-15 set background information for the contention timer. And, the contention timer is a subpart of the action section described in lines 2-15.

TABLE 1
Sample contention timer policy

| | |
|---|---|
| 1 | “actions”: { |
| 2 | // At this time, only API action is supported |
| 3 | // List of APIs to enact after policy is triggered |
| 4 | “api”: [ |
| 5 | { |
| 6 | // API Data |
| 7 | “method”: “POST”, |
| 8 | “url”: “https://action-url.com/”, |
| 9 | “headers”: { |
| 10 | “content-type”: “application/json”, |
| 11 | “additional_headers”: “value” |
| 12 | }, |
| 13 | “body”: { |
| 14 | “data”: “{event1.bm.entires[ ].objectInstanceId}” |
| 15 | }, |
| 16 | |
| 17 | // contention_timer data |
| 18 | // optional |
| 19 | // prime id |
| 20 | “prime_id”: “objectInstanceId”,/or the ID of the |

NF for which consecutive action to be avoided till contention timer
duration.

| | |
|---|---|
| 21 | |
| 22 | // optional |
| 23 | // contention time in seconds. defaults: 3600 |
| 24 | “contention_timer”: “3600” |
| 25 | } |
| 26 | ] |
| 27 | } |

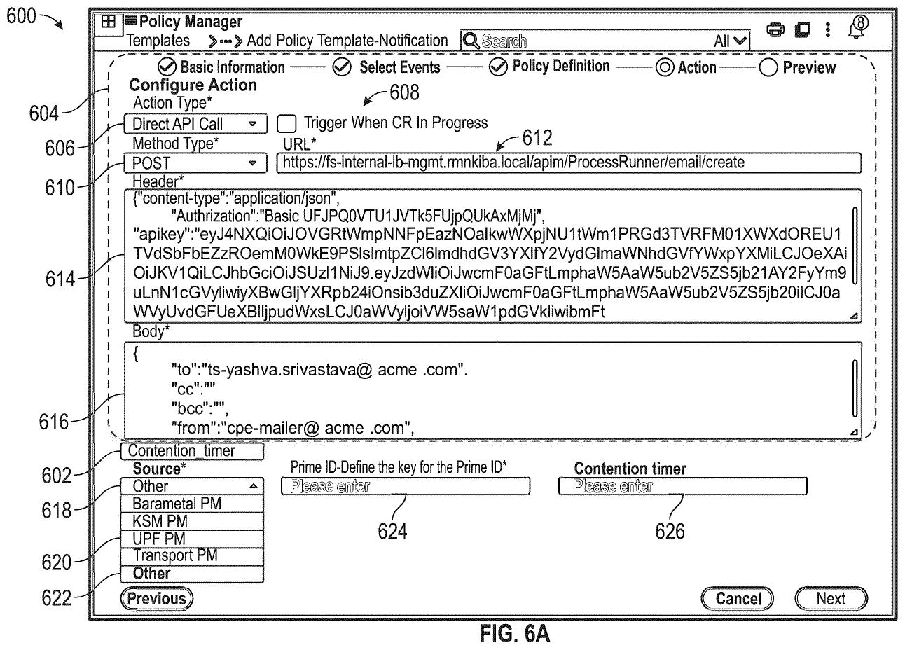

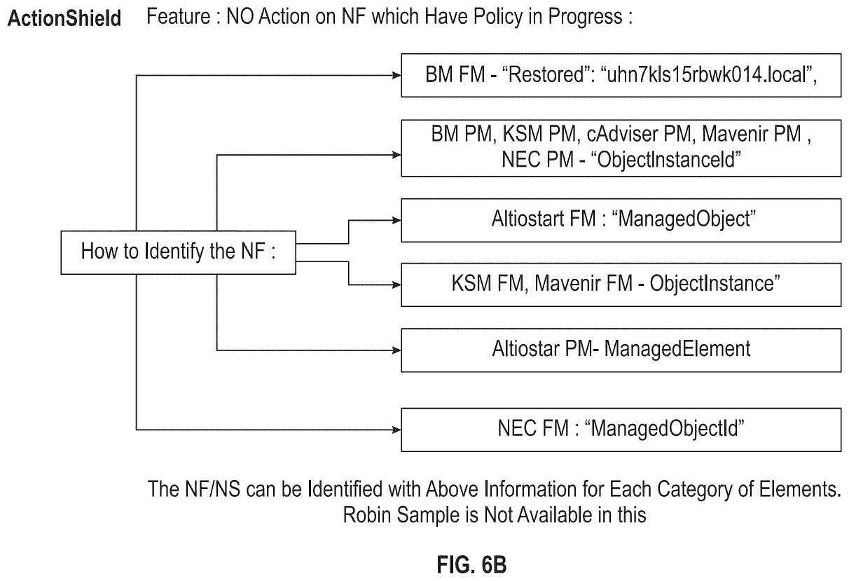

FIG. 6 is a graphical user interfaces (GUIs) 600 for a correlation and policy engine (CPE), in accordance with some embodiments.

In some embodiments, GUI 600 is displayed on a user interface, such as user interface 208 or 718, and a user sets activation triggers for contention timer 602.

During the process of developing a policy template using policy manager GUI 600, the user configures an action, at action block 604. The user is able to select and action type within action type user selection field 606; enable the action to trigger upon a change request (CR) at CR user selection field 608; set an action method at method type user selection filed 610; establish a uniform resource locator (URL) in which the action is reported at user input field 612; input an introductory header for the report in user input field 614; and input the body of the message in body user input field 616.

In addition to describing the action to be taken as part of the policy template, a user configures contention timer 602. The user selects a source of the fault at user selection field 618. User selection field 618 includes a down arrow, which when clicked displays a drop-down list 620, where the user is ablet to select from many sources. A drop-down list (abbreviated drop-down, or DDL; also known as a drop-down menu, drop menu, pull-down list, picklist) is a graphical control element, similar to a list box, that allows the user to choose one value from a list. When a drop-down list is inactive, it displays a single value. When activated, it displays (drops down) a list of values, from which the user selects one. When the user selects a new value, the control reverts to its inactive state, displaying the selected value.

In a non-limiting example, drop-down list 620 displays several preventive maintenance (PM) network functions, to select from. In highlighted box 622 a user selects other, when the available selections do not match the desired source of the action or event. The user inputs within user input field 624 the prime ID for the network function, network service, or network server the user configures the contention timer to be based upon. Finally, within user input field 626 the user inputs a value (e.g., in seconds, minutes, or hours) for the contention timer to be active after being triggered. In some embodiments, the default timer is 3,600 seconds (e.g., 1 hour).

As discussed above, no action is taken on a network function, network service, or network server when the contention timer is active. In some embodiments, the network function, network service, or network server is identified with information for each category of elements. In a non-limiting example, a preventive maintenance or fault maintenance (FM) have separate prime IDs as shown in FIG. 6B.

FIG. 7 is a block diagram of CPE system 700 in accordance with some embodiments. In some embodiments, CPE system 700 is a general-purpose computing device including a hardware processing circuitry 702 and a non-transitory, computer-readable storage medium 704. Storage medium 704, amongst other things, is encoded with, i.e., stores, computer instructions 706, i.e., a set of executable instructions such as a correlation engine and policy manager. Execution of instructions 706 by hardware processing circuitry 702 represents (at least in part) a CPE tool which implements a portion or all the methods, such as methods 400 and 500, described herein in accordance with one or more embodiments (hereinafter, the noted processes and/or methods).

Hardware processing circuitry 702 is electrically coupled to a computer-readable storage medium 704 via a bus 708. Hardware processing circuitry 702 is further electrically coupled to an I/O interface 710 by bus 708. A network interface 712 is further electrically connected to processing circuitry 702 via bus 708. Network interface 712 is connected to a network 714, so that processing circuitry 702 and computer-readable storage medium 704 connect to external elements via network 714. Processing circuitry 702 is configured to execute computer instructions 706 encoded in computer-readable storage medium 704 in order to cause CPE system 700 to be usable for performing the noted processes and/or methods, such as methods 400 and 500 of FIGS. 4 and 5. In one or more embodiments, processing circuitry 702 is a central processing unit (CPU), a multi-processor, a distributed processing system, an application specific integrated circuit (ASIC), and/or a suitable processing unit.

In one or more embodiments, computer-readable storage medium 704 is an electronic, magnetic, optical, electromagnetic, infrared, and/or a semiconductor system (or apparatus or device). For example, computer-readable storage medium 704 includes a semiconductor or solid-state memory, a magnetic tape, a removable computer diskette, a random-access memory (RAM), a read-memory (ROM), a rigid magnetic disk, and/or an optical disk. In one or more embodiments using optical disks, computer-readable storage medium 704 includes a compact disk-read memory (CD-ROM), a compact disk-read/write (CD-R/W), and/or a digital video disc (DVD).

In one or more embodiments, storage medium 704 stores computer instructions 706 configured to cause CPE system 700 to be usable for performing a portion or the noted processes and/or methods. In one or more embodiments, storage medium 704 further stores information, such as a correlation and policy engine which facilitates performing the noted processes and/or methods.

CPE system 700 includes I/O interface 710 that is like UI 208. I/O interface 710 is coupled to external circuitry. In one or more embodiments, I/O interface 710 includes a keyboard, keypad, mouse, trackball, trackpad, touchscreen, cursor direction keys and/or other suitable I/O interfaces are within the contemplated scope of the disclosure for communicating information and commands to processing circuitry 702.

CPE system 700 further includes network interface 712 coupled to processing circuitry 702. Network interface 712 allows CPE system 700 to communicate with network 714, to which one or more other computer systems are connected. Network interface 712 includes wireless network interfaces such as BLUETOOTH, WIFI, WIMAX, GPRS, or WCDMA; or wired network interfaces such as ETHERNET, USB, or IEEE-864. In one or more embodiments, noted processes and/or methods, is implemented in two or more CPE system 700.

CPE system 700 is configured to receive information through I/O interface 710. The information received through I/O interface 710 includes one or more of instructions, data, and/or other parameters for processing by processing circuitry 702. The information is transferred to processing circuitry 702 via bus 708. CPE system 700 is configured to receive information related to a UI through I/O interface 710. The information is stored in computer-readable medium 704 as user interface (UI) 208.

In some embodiments, the noted processes and/or methods are implemented as a standalone software application for execution by processing circuitry. In some embodiments, the noted processes and/or methods are implemented as a software application that is a part of an additional software application. In some embodiments, the noted processes and/or methods is implemented as a plug-in to a software application.

In some embodiments, the processes are realized as functions of a program stored in a non-transitory computer readable recording medium. Examples of a non-transitory computer-readable recording medium include, but are not limited to, external/removable and/or internal/built-in storage or memory unit, e.g., one or more of an optical disk, such as a DVD, a magnetic disk, such as a hard disk, a semiconductor memory, such as a ROM, a RAM, a memory card, and the like.

In some embodiments, a system includes processing circuitry; and a memory connected to the processing circuitry, wherein the memory is configured to store executable instructions that, when executed by the processing circuitry, facilitate performance of operations, including receive contention timer parameters corresponding to a business-policy; receive one or more event messages from network element groups; filter the one or more event messages for monitoring; generate an action to be initiated by an action resource in response to a detected fault; and initiate a contention timer in response to the generation of the action to be taken by the action resource based on the detected fault.

In some embodiments, the executable instructions further facilitate performance of operations to before the initiation of the contention timer, determine whether the contention timer is currently active.

In some embodiments, the executable instructions further facilitate performance of operations to in response to the contention timer being active, discard the action to be initiated by the action resource.

In some embodiments, the executable instructions further facilitate performance of operations to in response to the contention timer being inactive, initiate the action by the action resource.

In some embodiments, the executable instructions further facilitate performance of operations to cause a graphical user interface (GUI) to be output by a user interface (UI), the GUI includes a first user input field configured to accept a user input for a duration of the contention timer.

In some embodiments, the executable instructions further facilitate performance of operations to further cause the GUI to output a second user input field configured to accept a user input for an ID that corresponds to a network element where the detected fault generated.

In some embodiments, the executable instructions further facilitate performance of operations to further cause the GUI to output a third user input field configured to accept a user input for a source of the network element.

In some embodiments, a method executed by a processor includes receiving contention timer parameters corresponding to a business-policy; receiving one or more event messages from network element groups; filtering the one or more event messages for monitoring; generating an action to be initiated by an action resource in response to a detected fault; and initiating a contention timer in response to the generation of the action to be taken by the action resource based on the detected fault.

In some embodiments, the method further includes before the initiation of the contention timer, determining whether the contention timer is currently active.

In some embodiments, the method further includes in response to the contention timer being active, discarding the action to be initiated by the action resource.

In some embodiments, the method further includes in response to the contention timer being inactive, initiating the action by the action resource.

In some embodiments, the method further includes causing a graphical user interface (GUI) to be output by a user interface (UI), the GUI including a first user input field configured to accept a user input for a duration of the contention timer.

In some embodiments, the method further includes further causing the GUI to output a second user input field configured to accept a user input for an ID that corresponds to a network element where the detected fault generated.

In some embodiments, the method further includes further causing the GUI to output a third user input field configured to accept a user input for a source of the network element.

In some embodiments, a non-transitory, tangible computer readable storage medium storing a computer program, wherein the computer program contains instructions that when executed, cause a processor to perform operations including receive contention timer parameters corresponding to a business-policy; receive one or more event messages from network element groups; filter the one or more event messages for monitoring; generate an action to be initiated by an action resource in response to a detected fault; and initiate a contention timer in response to the generation of the action to be taken by the action resource based on the detected fault.

In some embodiments, the executable instructions further facilitate performance of operations to before the initiation of the contention timer, determine whether the contention timer is currently active.

In some embodiments, the executable instructions further facilitate performance of operations to in response to the contention timer being active, discard the action to be initiated by the action resource.

In some embodiments, the executable instructions further facilitate performance of operations to in response to the contention timer being inactive, initiate the action by the action resource.

In some embodiments, the executable instructions further facilitate performance of operations to cause a graphical user interface (GUI) to be output by a user interface (UI), the GUI including a first user input field configured to accept a user input for a duration of the contention timer.

In some embodiments, the executable instructions further facilitate performance of operations to further cause the GUI to output a second user input field configured to accept a user input for an ID that corresponds to a network element where the detected fault generated.

The foregoing outlines features of several embodiments so that those skilled in the art better understand the aspects of the present disclosure. Those skilled in the art should appreciate that they readily use the present disclosure as a basis for designing or modifying other processes and structures for carrying out the same purposes and/or achieving the same advantages of the embodiments introduced herein. Those skilled in the art should further realize that such equivalent constructions do not depart from the spirit and scope of the present disclosure, and that they make various changes, substitutions, and alterations herein without departing from the spirit and scope of the present disclosure.

What is claimed is:

1. A system, comprising:
processing circuitry; and
a memory connected to the processing circuitry, wherein the memory is configured to store executable instructions that, when executed by the processing circuitry, facilitate performance of operations, comprising:
receive contention timer parameters corresponding to a business-policy;
receive one or more event messages from network element groups;
filter the one or more event messages for monitoring;
generate an action to be initiated by an action resource in response to a detected fault; and
initiate a contention timer in response to the generation of the action to be taken by the action resource based on the detected fault.

2. The system of claim 1, wherein the executable instructions further facilitate performance of operations to:
before the initiation of the contention timer, determine whether the contention timer is currently active.

3. The system of claim 2, wherein the executable instructions further facilitate performance of operations to:
in response to the contention timer being active, discard the action to be initiated by the action resource.

4. The system of claim 2, wherein the executable instructions further facilitate performance of operations to:
in response to the contention timer being inactive, initiate the action by the action resource.

5. The system of claim 1, wherein the executable instructions further facilitate performance of operations to:
cause a graphical user interface (GUI) to be output by a user interface (UI), the GUI comprising:
a first user input field configured to accept a user input for a duration of the contention timer.

6. The system of claim 5, wherein the executable instructions further facilitate performance of operations to:
further cause the GUI to output:
a second user input field configured to accept a user input for an ID that corresponds to a network element where the detected fault generated.

7. The system of claim 6, wherein the executable instructions further facilitate performance of operations to:
further cause the GUI to output:
a third user input field configured to accept a user input for a source of the network element.

8. A method executed by a processor, comprising:
receiving contention timer parameters corresponding to a business-policy;
receiving one or more event messages from network element groups;
filtering the one or more event messages for monitoring;
generating an action to be initiated by an action resource in response to a detected fault; and
initiating a contention timer in response to the generation of the action to be taken by the action resource based on the detected fault.

9. The method of claim 8, further comprising:
before the initiation of the contention timer, determining whether the contention timer is currently active.

10. The method of claim 9, further comprising:
in response to the contention timer being active, discarding the action to be initiated by the action resource.

11. The method of claim 9, further comprising:
in response to the contention timer being inactive, initiating the action by the action resource.

12. The method of claim 8, further comprising:
causing a graphical user interface (GUI) to be output by a user interface (UI), the GUI comprising:
a first user input field configured to accept a user input for a duration of the contention timer.

13. The method of claim 12, further comprising:
further causing the GUI to output:
a second user input field configured to accept a user input for an ID that corresponds to a network element where the detected fault generated.

14. The method of claim 13, further comprising:
further causing the GUI to output:
a third user input field configured to accept a user input for a source of the network element.

15. A non-transitory, tangible computer readable storage medium storing a computer program, wherein the computer program contains instructions that when executed, cause a processor to perform operations comprising:
receive contention timer parameters corresponding to a business-policy;
receive one or more event messages from network element groups;
filter the one or more event messages for monitoring;
generate an action to be initiated by an action resource in response to a detected fault; and
initiate a contention timer in response to the generation of the action to be taken by the action resource based on the detected fault.

16. The non-transitory, tangible computer readable storage medium of claim 15, wherein the executable instructions further facilitate performance of operations to:
before the initiation of the contention timer, determine whether the contention timer is currently active.

17. The non-transitory, tangible computer readable storage medium of claim 16, wherein the executable instructions further facilitate performance of operations to:
in response to the contention timer being active, discard the action to be initiated by the action resource.

18. The non-transitory, tangible computer readable storage medium of claim 16, wherein the executable instructions further facilitate performance of operations to:
in response to the contention timer being inactive, initiate the action by the action resource.

19. The non-transitory, tangible computer readable storage medium of claim 15, wherein the executable instructions further facilitate performance of operations to:
cause a graphical user interface (GUI) to be output by a user interface (UI), the GUI comprising:
a first user input field configured to accept a user input for a duration of the contention timer.

20. The non-transitory, tangible computer readable storage medium of claim 19, wherein the executable instructions further facilitate performance of operations to:
further cause the GUI to output:
a second user input field configured to accept a user input for an ID that corresponds to a network element where the detected fault generated.
